(19) United States
(12) Patent Application Publication
(10) Pub. No.: US 2026/0359250 A1
(43) Pub. Date: Nov. 12, 2026

(54) TERMINATION DEVICE FOR A COMMUNICATION BUS

(71) Applicant: Advanced Micro Devices, Inc., Santa Clara, CA (US)

(72) Inventors: Wayne Paul RODRIGUE, Buda, TX (US); Jerry Anton AHRENS, JR., Sister Bay, WI (US); Grant Evan LEY, Eden, UT (US); William R. ALVERSON, Del Valle, TX (US); Anwar Parvez KASHEM, Sudbury, MA (US); Joshua Taylor KNIGHT, Georgetown, TX (US); Manjunath SHIVAPPA, Austin, TX (US)

(21) Appl. No.: 19/201,687

(22) Filed: May 7, 2025

(51) Int. Cl. G06F 13/40; G06F 9/4401

(52) U.S. Cl. CPC G06F 13/4086; G06F 9/4411

(57) ABSTRACT

A termination device for a computer system includes conductive pins and control circuitry. The termination device mitigates mismatched (or misaligned) signal reflections within a corresponding communication bus of the computer system. The conductive pins connect to a socket of the computer system. The control circuitry outputs, via the conductive pins, a first signal to the communication bus of the computer system. The control circuitry further adjusts a parameter of the termination device based on a data signal associated with the first signal. Further, the control circuitry outputs a second signal to the communication bus based on the adjusted parameter via the conductive pins.

### TECHNICAL FIELD

Examples of the present disclosure generally relate to a termination device for a communication bus, and, more specifically, improving signal integrity of a communication bus using a termination device.

### BACKGROUND

High speed communication interfaces are used to communicate data and other signals between integrated circuit (IC) devices. A high-speed communication interface may be used to communicate data between a processing device (e.g., a central processing unit or a graphics processing unit, among others) and a memory device, or another type of IC device. A high-speed communication interface may be a point to point interface and comprises a tuned closed loop circuit, allowing for increased transfer rates. In a closed loop circuit, signals travel from the source (e.g., the processing device), through intermediaries (e.g., package routings and sockets) to the receiver (e.g., an IC device or another load). In a tuned closed loop circuit, the termination element within the tuned closed loop circuit is tuned to mitigate reflections within and improve signal integrity of the closed loop circuit.

A computer system may include multiple sockets (connectors) along a communication bus to support expandability and different configurations. Multiple sockets may be included and connected to a communication bus. However, empty sockets (e.g., unused sockets or connectors) along a communication bus introduce routed stubs and un-tuned reflection points, lowering the signal integrity of the communication bus and reducing the maximum operating speed of the bus. Thus, there is a need for a termination device that can be added to an empty socket or sockets of a computer system and that is tunable to mitigate reflections and to improve signal integrity within the computer system.

### SUMMARY

In one or more examples, a termination device includes conductive pins and control circuitry. The conductive pins connect to a socket of a computer system. The control circuitry outputs, via the conductive pins, a first signal to a communication bus of the computer system. The control circuitry further adjusts a parameter of the termination device based on a data signal associated with the first signal. Further, the control circuitry outputs a second signal to the communication bus based on the adjusted parameter via the conductive pins.

In one or more examples, a method includes outputting, via control circuitry of a termination device, a first signal to a communication bus of a computer system. The control circuitry is connected to a computer system. The method further includes adjusting, via the control circuitry, a parameter of the termination device based on a data signal associated with the first signal. Further, the method includes outputting, via the control circuitry, via the conductive pins, a second signal to the communication bus based on the adjusted parameter.

In one or more examples, a computer system includes a processing device, an integrated circuit (IC) device, and a termination device. The processing device outputs data signals. The IC device is connected to the processing device via a communication bus, receives the data signals, and samples the data signals. The termination device is connected to the processing device via the communication bus. A parameter of the termination device is adjustable based on the sampled data signals.

These and other aspects may be understood with reference to the following detailed description.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a block diagram of a computer system.

FIG. 2 illustrates a block diagram of a termination device.

FIG. 3 illustrates a block diagram of a termination device configured as a dual in-line memory module.

FIG. 4 illustrates a flowchart of a method for turning a termination device.

FIG. 5 illustrates a block diagram of a computer system including a termination device and an integrated circuit device connected to processing device via a communication bus.

FIG. 6 illustrates an example eye diagram for a data signal.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

A computer system uses a high-speed communication interface or interfaces to communicate with integrated circuit (IC) devices within the computer system. For example, a high-speed communication interface can be used to communicate between a processing device (e.g., a central processing unit (CPU) or a graphics processing unit (GPU), among others), and a memory device or another type of IC device. In another example, a high-speed communication interface may be used to communicate between other IC devices within a computer system.

In a high-speed communication interface, signals are routed from a first IC device to a second IC device. For example in a computer system, signals are communicated between IC devices via a communication bus. A communication device includes conductive traces routed on one or more layers of a substrate (e.g., package substrate) and sockets (e.g., connectors) on the substrate. The conductive traces connect the processing device with the sockets, allowing for signals to be communicated between IC devices (e.g., between processing device and an IC device) installed within the sockets. To increase the expandability and design flexibility of a computer system, the computer system may include multiple sockets connected to a communication bus. However, an empty socket along a communication bus (e.g., a socket in which an IC device is not installed) can introduce signal reflections and decrease signal integrity along the communication bus.

In the following, a termination device is described. The termination device can be installed within a socket of a communication interface. The termination device mitigates mismatched (or misaligned) signal reflections within a corresponding communication bus, improving the signal integrity of the communication bus. For example, the termination device includes tunable parameters (e.g., a tunable output voltage and/or a tunable resistance, or another parameter) that allows for the termination device to mitigate mismatched (or misaligned) signal reflections within a communication bus to improve the signal integrity along the communication bus.

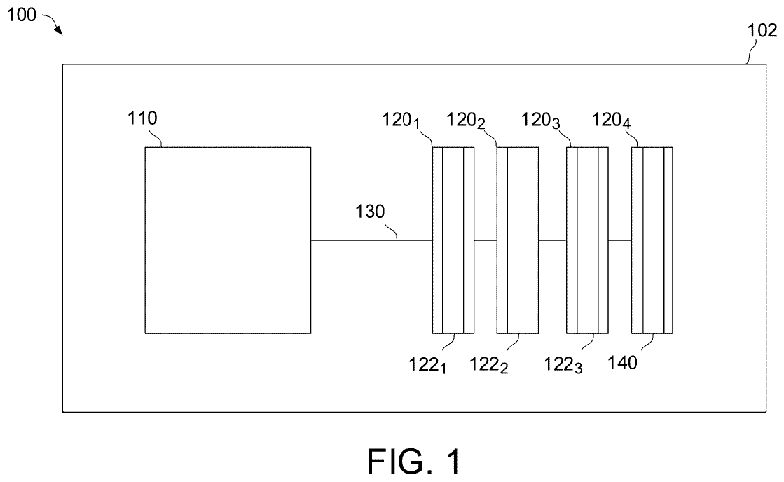

FIG. 1 illustrates a block diagram of a computer system 100. The computer system 100 includes a processing device 110, sockets 120, memory modules 122, a communication bus 130, and a termination device 140. The computer system 100 may be personal computer system. In other examples, the computer system 100 is part of a distributed computer system. In such an example, the computer system 100 may be referred to as a server. Further, in a distributed computer system, the computer system 100 is connected (e.g., a wireless and/or wired connection) to other computer systems to perform various operations.

The processing device 110 is a CPU or a GPU, among others. In one example, the computer system 100 includes one or more processing devices. In such an example, the processing devices 110 may be the same type or different types.

The processing device 110 is connected to the memory modules 122 via the sockets 120 and the communication bus 130. In one or more examples, the communication bus 130 includes one or more conductive traces that are used to connect the processing device 110 with the sockets 120.

In one or more examples, the processing device 110 and the sockets 120 are disposed on a printed circuit board (PCB) 102 (or another type of substrate) of the computer system 100. The one or more conductive traces forming the communication bus 130 are formed within one or more layers of the PCB 102.

The memory modules 122 are mounted (e.g., installed) within the sockets 120. The sockets 120 are electrically connected to the communication bus 130. In one example, the sockets 120 are physically and electrically connected to the memory modules 122. A memory module 122 mounted within a socket 120 is electrically connected to the communication bus via the socket 120. In one example, the sockets 120 include a clamping mechanism that holds the memory modules 122. The sockets 120 may be referred to as a connector. The memory modules 122 are connected to the communication bus 130 via the sockets 120.

Each of the memory modules 122 includes one or more memory devices. A memory module 122 may be a dual in-line memory module (DIMM). In other examples, other types of memory modules 122 may be used. The number of memory devices corresponds to the memory capacity of a memory module 122.

The memory devices may be double data rate (DDR) memory devices. In other examples, other types of memory devices may be used. The memory devices may be disposed in rows and columns on one or two sides of a memory module 122. In one example, increasing a size of a memory module 122 increases the number of rows of memory devices that can be included on the memory module 122, increasing the memory capacity of the memory module 122 and corresponding computer system (e.g., the computer system 100).

In one example, the computer system 100 further includes the termination device 140. The termination device 140 is mounted (e.g., installed) in the socket 120₄. In one example, the socket 120₄ is physically and electrically connected to the termination device 140. In one example, the socket 120₄ includes a clamping mechanism that holds the termination device 140. In other examples, the termination device 140 may be mounted in any of the sockets 120. In one or more examples, the termination device 140 is mounted in a socket 120 that is between two sockets 120 in which a memory module 122 is mounted. For example, the termination device 140 may be mounted in the socket 120₂ instead of the memory device 122₂.

The termination device 140 is connected to the communication bus 130 via the socket 120₄. As is described in greater detail in the following, one or more parameters of the termination device 140 are adjustable (or tunable) to mitigate mismatched (or misaligned) reflections and/or improve signal integrity of the communication bus 130. Further, the termination device 140 can be tuned to dynamically mitigate destructive reflections within the communication bus 130 to provide a wider signaling eye.

In one example, one or more of the sockets 120 is empty. An empty socket 120 does not include a corresponding memory module 122 and/or termination device 140 mounted therein. Further, in one or more examples, the computer system 100 includes more than or less than four sockets 120.

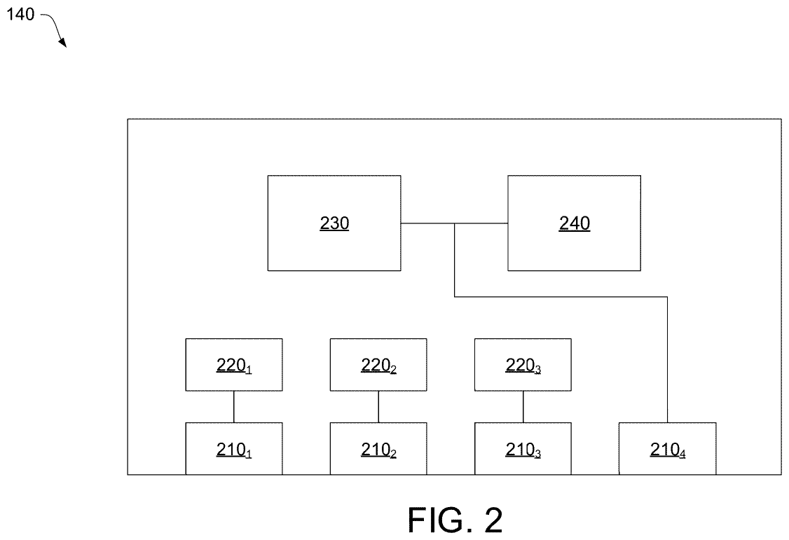

FIG. 2 illustrates a block diagram of a termination device 140. The termination device 140 includes pins 210, resistors 220, control circuitry 230, and serial present detector (SPD) circuitry 240.

The pins 210 are conductive connectors that interact with conductive connectors of the sockets 120. The pins 210 provide an electrical connection to the sockets 120. The pins 210 communicate signals between the termination device 140 and the sockets 120. In one example, one or more of the pins 210 are connected to one of the resistors 220. For example, the pin 210₁ is connected to the resistor 220₁, the pin 210₂ is connected to the resistor 220₂, and the pin 210₃ is connected to the resistor 220₃. In other examples, the termination device 140 includes more than or less than four pins and/or more than or less than three resistors.

The control circuitry 230 is connected to the pin 210₄. In one example, the control circuitry 230 is a power management integrated circuit (PMIC). In other examples, the control circuitry 230 is an IC device that is able to control and regulate power within the termination device 140. In one example, the control circuitry 230 outputs a voltage signal via the pin 210₄. The voltage of the voltage signal output by the control circuitry 230 is variable or selectable. For example, the control circuitry 230 is controlled to output a voltage signal having a voltage within a range of voltages. In one example, the control circuitry 230 receives a control signal from a processing device (e.g., the processing device 110 of FIG. 1) and outputs a voltage signal having a voltage value based on the control signal. In such an example, the control signal is received via the communication bus 130. In one or more examples, the voltage output by the control circuitry 230 is tuned by the processing device as is described in greater detail in the following.

The SPD circuitry 240 is connected to the pin 210₄. The SPD circuitry 240 communicates with a processing device (e.g., the processing device 110 of FIG. 1) and provides an indication to the processing device via a control signal that the termination device 140 is mounted within a corresponding socket (e.g., the socket 120₄ of FIG. 1). The SPD circuitry 240 communicates the presence of the termination device 140, the tunable voltages of the termination device 140, and/or other information regarding parameters about the termination device 140.

The resistors 220 are connected to the pins 210 that are associated with data signals. In other examples, the resistors 220 are connected to the pins 210 that are associated with other types of signals. In one or more examples, the pins 210 associated with control signals, command address signals, alert signals, and/or reset signals are not connected to a corresponding resistor 220. In one example, resistors 220 are connected to the data pins of the pins 210, the data strobe pins of the pins 210, the error correction pins of the pins 210, and/or the data mask pins of the pins 210.

The resistors 220 have a resistance in a range of about 10 ohms to about 100 ohms. In other examples, the resistors 220 may have a resistance of less than 10 ohm and/or greater than 100 ohms. Further, in one or more examples, two or more resistors 220 may have a different resistance. In other examples, at least two resistors have the same resistance.

In one example, a distance between a resistor 220 and a corresponding pin 210 is selected to mitigate a corresponding parasitic capacitance. For example, a resistor 220 disposed a distance from a corresponding pin 210 to mitigate an associated parasitic capacitance.

In one example, one or more of the resistors 220 are variable resistors. For example, the resistance of the one or more of the resistors 220 is adjustable by the control circuitry 230. The control circuitry 230 may vary a resistance of one or more of the resistors 220 based on a received control signal. Varying the resistance of one or more the resistors 220 may improve the signal integrity of a corresponding communication bus (e.g., the communication bus 130 of FIG. 1).

In one example, the termination device 140 may include a light and/or audible communication system that outputs information related to the boot information for the corresponding computer system, training information for the termination card (e.g., training errors or other information), communication bus operation information, and/or other operational information (e.g., whether or not the termination device is in a training mode).

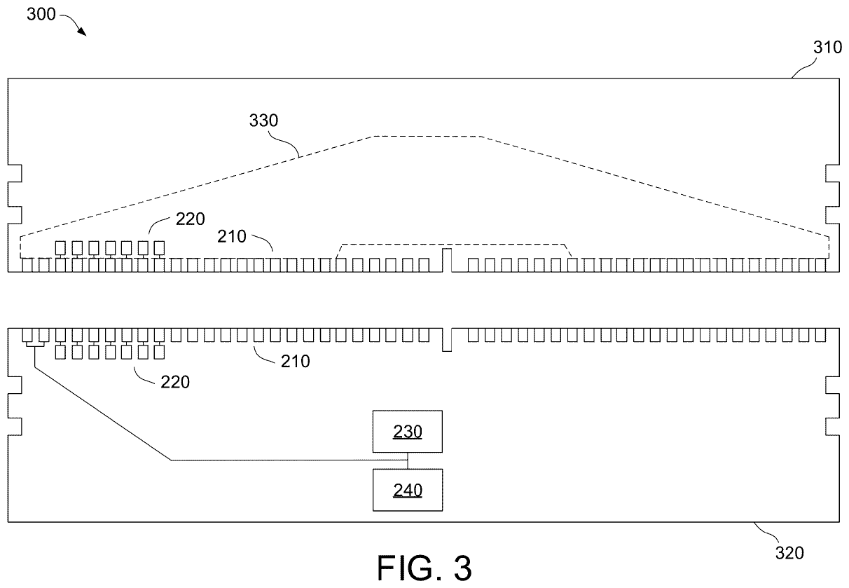

FIG. 3 illustrates an example termination device 300. The termination device 300 is a dual sided device, including a first side 310 and a second side 320. The first side 310 is opposite the second side 320. As is illustrated in FIG. 3, the termination device 300 includes the pins 210, the resistors 220, the control circuitry 230, and the SPD circuitry 240. The pins 210 and the resistors 220 are mounted to the first side 310 and the second side 320 of the termination device 300. The control circuitry 230 and the SPD circuitry 240 are mounted to the second side 320. In another example, the control circuitry 230 is mounted to a different one of the first side 310 and the second side 320 than the SPD circuitry 240. Further, on the first side 310 the pins 210 and the resistors 220 are within the power plane 330. In one or more examples, the resistors 220 are connected to the power plane 330. Further, the termination device 300 may have a shape similar to that of a DIMM that is to be mounted within a connector (e.g., the socket 120 of FIG. 1). In other examples, the termination device 300 may have a shape that differs from that of a DIMM.

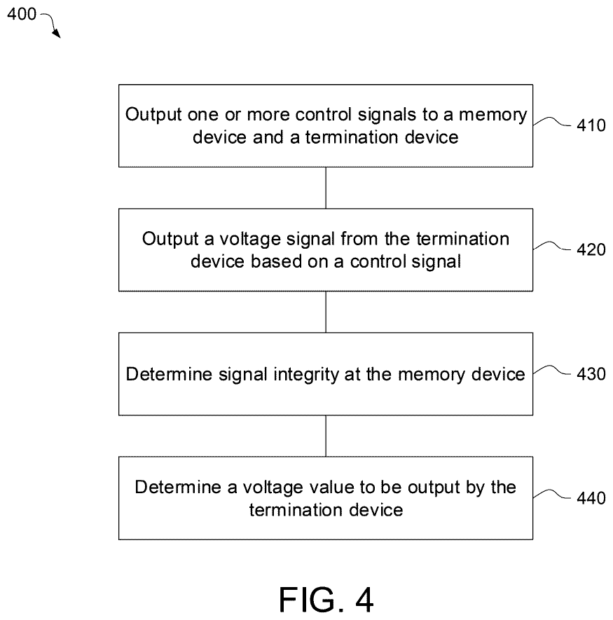

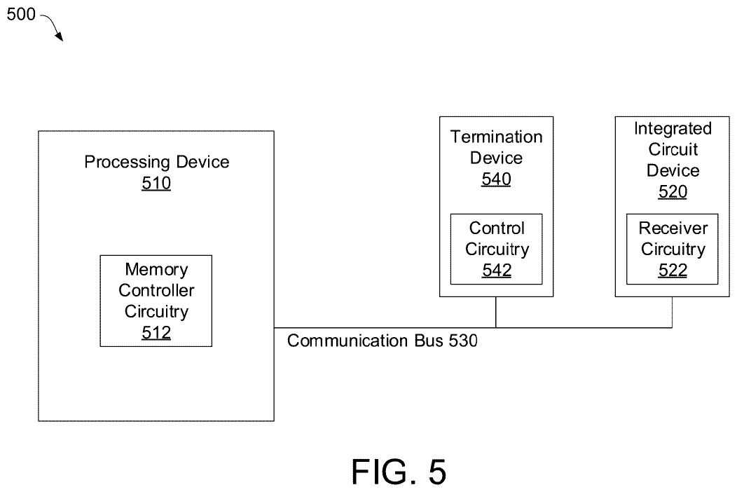

FIG. 4 illustrates flowchart of a method 400 for training a termination device of a computer system. In one example, the method 400 is performed by the computer system 500 of FIG. 5. In one example, the computer system 500 is configured similar to the computer system 100 of FIG. 1. The method 400 may be performed at boot up or power up of the computer system 500, after a reset of the computer system 500, and/or another operating time of the computer system 500. For example, one or more parameters of a termination device are adjusted (e.g., tuned) during a boot process (e.g., boot up, power up or after reset, among others) of a computer system.

At operation 410 of the method 400, control signals are output to a memory device and a termination device. For example, with reference to FIG. 5, control signals are generated and output by the memory controller circuitry 512 of the processing device 510. The processing device 510 is configured similar to the processing device 110 of FIG. 1. The memory controller circuitry 512 generates the control signal(s) based on one or more control signals of the processing device 510. The memory controller circuitry 512 is connected to the termination device 540 and the IC device 520 via the communication bus 530. The communication bus 530 is configured similar to the communication bus 130 of FIG. 1. Further, the termination device 540 is configured similar to the termination device 140 of FIG. 1. In one example, the IC device 520 is configured similar to the memory module 122 of FIG. 1. In other examples, the IC device 520 may be a type of an IC device other than a memory device.

At operation 420 of the method 400, a first voltage signal is output by the termination device 540. For example, the termination device 540 includes the control circuitry 542. The control circuitry 542 is configured similar to the control circuitry 230 of FIG. 2. The control circuitry 542 receives a control signal (or signals) from the memory controller circuitry 512. The control circuitry 542 sets an output voltage based on the control signal. For example, the control circuitry 542 outputs a voltage signal having a first voltage value. The first voltage value is selected from a range of voltage values. In one example, the range of voltages is between about 0.8 V and about 1.5 V. In other examples, the range of voltages may include voltage values less than 0.8 V and/or greater than 1.5 V.

The termination device 540 outputs a voltage signal having the first voltage value on the communication bus 530, to mitigate mismatched (or misaligned) reflections within the communication bus 530 and to improve signal integrity within the communication bus 530.

At operation 430 of the method 400, the signal integrity at the memory device is determined. The IC device 520 includes the receiver circuitry 522 that receives a control signal (or signals) from the memory controller circuitry 512 via the communication bus. The control signal indicates the initialization of training of the IC device 520. In one example, the control signals include a voltage signal or signals. The voltage signal may be a multi-level voltage signal. In one or more examples, the voltage signal is a data signal.

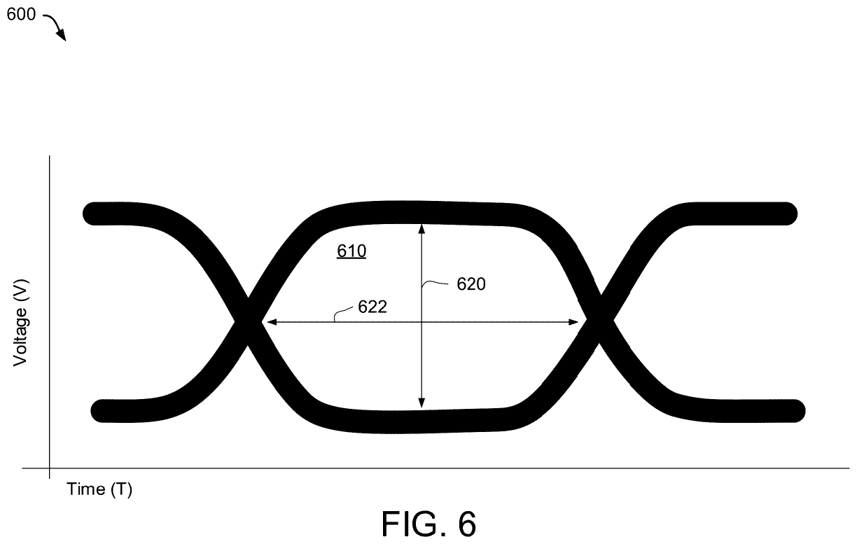

The voltage signal is received by the receiver circuitry 522 and is sampled. In one example, an eye diagram (e.g., the eye diagram 600 of FIG. 6) is generated from the voltage signal. The eye diagram 600 is generated by overlaying multiple data bits. In the eye diagram 600, the vertical axis is voltage (V) and the horizontal axis is Time (T). They eye diagram 600 may be used to determine data signal transitions between voltage levels. The opening 610 of the eye diagram 600 is measured to determine the corresponding signal integrity. A larger opening 610 indicates a higher signal integrity and less mismatched (or misaligned) signal reflections. In one example, the size of the opening 610 is determined by determining the height 620 and width 622 of the opening 610. In one or more examples, the size of the opening 610 is determined by determining the area of the opening 610.

In one or more examples, the voltage signal output by the termination device alters the opening 610 within the eye diagram 600. For example, the voltage signal output by the termination device may increase the size (e.g., height, width, and/or area) of the opening 610 or decrease the size of the opening 610. In one example, the memory controller circuitry 512 generates the eye diagram 600 from the samples generated by the receiver circuitry 522, and determines if the size of the opening 610 changed. For example, the memory controller circuitry 512 compares the size of the opening 610 to the size of a previously determined opening of an eye diagram to determine whether not the size changed (e.g., increased or decreased).

In one example, the operations 420 and 430 are repeated with different voltage values output by the control circuitry 542 of the termination device 540. In one example, the operation 420 is repeated by selecting and outputting different voltage values as different voltage signals on the communication bus 530 based on different control signals received from the memory controller circuitry 512. Stated another way, the voltage values of the voltage signal output by the control circuitry 542 of the termination device 540 are swept through based on the control signals.

For each different voltage value output by the termination device 540, the IC device 520 determines the corresponding signal integrity by generating an eye diagram as illustrated in FIG. 6, and measuring a size (e.g., height, width, and/or area) of an opening within a corresponding eye diagram. In one example, the IC device 520 samples data signals received from the memory controller circuitry 512 for each different voltage value output by the termination device 540, and generates a corresponding eye diagram. Sampling a data signal, or data signals, generates a sampled data signal, or sampled data signals. In one example, sampling a data signal generates samples. In one example for each different voltage value output by the termination device 540, the IC device 520 generates samples from received data signals. The IC device 520 outputs the different set of samples (e.g., a set generated for each voltage value output from the termination device) the memory controller circuitry 512, and the memory controller circuitry 512 determines the eye diagram for each set of samples. In one or more examples, a parameter, or parameters, of the termination device 540 are adjusted (e.g., tuned) based on the sampled data signal, or signals.

In one example, the processing device 510 includes a memory device that stores the voltage value output by the termination device 540 with an associated signal integrity determined by samples generated by the IC device 520. In one example for each voltage value output by the termination device 540, an eye diagram is stored and for each associated voltage value output by the termination device 540. Storing the eye diagram may include storing the entire eye diagram. In one or more examples, storing the eye diagram includes storing the width, height, area, and/or another size parameter of the eye opening of the eye diagram.

At operation 440 of the method 400, a voltage value to be output by the termination device is determined. In one example, the memory controller circuitry 512 determines a voltage value to be output by the termination device based on the measured signal integrity of the data signals received by the receiver circuitry 522 of the IC device 520. For example, the measured signal integrity for each set of data signals received by the IC device 520 for each different voltage value output by the termination device 540 is used to determine the voltage value to be output by the termination device 540. Determining the voltage value to be output by the termination device 540 may be referred to as tuning the termination device 540.

In one example, the memory controller circuitry 512 determines the voltage value to be output by the termination device (e.g., tunes the termination device) based on the size of the eye opening in each eye diagram determined for each different voltage value output by the termination device 540. The memory controller circuitry 512 determines the voltage value that is associated with the eye diagram having the opening with largest height, width, and/or area.

The memory controller circuitry 512 outputs a tuning command signal having an indication of the determined voltage value to the control circuitry 542 of the termination device 540 via the communication bus 530. The control circuitry 542 receives the tuning command signal and outputs a voltage signal having the determined voltage value. By outputting the voltage signal having the determined voltage value, mismatched (or misaligned) reflections along the communication bus 530 are mitigated, and signal integrity of the communication bus 530 is increased.

In one or more examples, the termination device 540 is disabled. For example, the termination device 540 may be disabled during one or more boot stages and/or training stages of the computer system 500. In one or more examples, the termination device 540 is disabled during a period that at least partially overlaps with a period during which the IC device 520 (and/or another IC device of the computer system 500) is trained. The termination device 540 may be disabled when training the data link, clock signal link and/or error correction link of the IC device 520. In one or more examples, the memory controller circuitry 512 outputs a control signal to the control circuitry 542 that has an indication to disable the termination device 540. The control circuitry 542 receives the control signal and disables the termination device 540 based on the control signal. In one or more examples, the termination device 540 is disabled during a period that at least partially overlaps with one or more boot stages of the processing device 510 and/or the computer system 500. Disabling the termination device 540 allows the computer system 500 to properly train an IC device connected to the communication bus 530 and/or complete the boot processes of the computer system 500.

In one example, the method 400 includes adjusting a resistance of one or more resistors (e.g., the resistors 220 of FIG. 2) of the determination circuitry. For example, the operation 420 of the method 400 may, alternatively, or additionally, include adjusting a resistance of one or more resistors of the termination device 540 based on the control signal. In one example at operation 420 of the method 400, the control circuitry 542 of the termination device 540 adjusts a resistance value of one or more resistors of the termination device 540 based on a control signal. At the operation 430, a signal integrity is determined at the memory device for each different resistance of the termination device 540. In one example, the resistance value of one or more resistors of the termination device 540 is swept through multiple resistance values, and the signal integrity for each resistance value is determined at operation 430. At operation 440, a resistance value or values is selected based on the corresponding determined signal integrities, and the termination device 540 is tuned based on the selected resistance value or values. In one example, a resistance value (or values) and a voltage value are selected based on the corresponding determined signal integrities as is described above with regard to operation 440, and the termination device 540 is tuned based on the selected resistance value (or values) and the voltage value.

While FIG. 5 illustrates the computer system 500 having one termination device (e.g., the termination device 540), in other examples, the computer system 500 may include multiple termination devices. Each termination device may be tuned as is described above with regard to the method 400. Further, the termination device 540 may be included in any open (or empty) socket connected to the communication bus 530. For example, the communication bus 530 may include two or more open sockets, and the termination device 540 may be connected (e.g., mounted or inserted) within any of the open sockets. In one example, an empty socket is along the communication bus and between the IC device 520 and the processing device 510. In another example, an empty socket is along the communication bus and the IC device 520 is between the empty socket and the processing device 510. In another example, multiple empty socket can be anywhere along the communication bus 530 with reference to the processing device 510, and the termination device 540 may be mounted within any of the empty sockets and tuned as described above with regard to the method 400.

A communication bus for a computer system can include one or more empty sockets. To mitigate mismatched (or misaligned) signal reflections within the communication caused by the empty socket or sockets, a termination device is inserted within an empty socket. Parameters of the termination device are tuned to mitigate mismatched (or misaligned) signal reflections within a corresponding communication bus, improving the signal integrity of the communication bus.

While the foregoing is directed to specific examples, other and further examples may be devised without departing from the basic scope thereof, and the scope thereof is determined by the claims that follow.

What is claimed is:

1. A termination device comprising:
conductive pins configured to connect to a socket of a computer system; and
control circuitry configured to:
output, via the conductive pins, a first signal to a communication bus of the computer system;
adjust a parameter of the termination device based on a data signal associated with the first signal; and
output, via the conductive pins, a second signal to the communication bus based on the adjusted parameter.

2. The termination device of claim 1, wherein the first signal is a first voltage signal, and the second signal is a second voltage signal, wherein a voltage value of the first voltage signal differs from a voltage value of the second voltage signal.

3. The termination device of claim 2, wherein adjusting the parameter of the termination device comprises adjusting a tunable output voltage of the termination device.

4. The termination device of claim 2, wherein the control circuitry is configured to output a plurality of voltage signals having different voltage values, wherein the plurality of voltage signals includes the first voltage signal and the second voltage signal, and wherein a signal integrity of a data signal associated with each of the plurality of voltage signals is determined.

5. The termination device of claim 4, wherein adjusting the parameter of the termination device is based on the signal integrity of the data signal.

6. The termination device of claim 1, further comprising resistors, and wherein adjusting the parameter of the termination device comprises adjusting a resistance of one or more of the resistors of the termination device.

7. The termination device of claim 1, further comprising:
serial present detector circuitry configured to output a control signal indicating presence of the termination device mounted within the socket of the computer system; and
resistors connected to first conductive pins of the conductive pins, wherein the first conductive pins are associated with data signals, wherein the control circuitry is a power management integrated circuit configured to output the first signal and the second signal.

8. The termination device of claim 1, wherein at least one of:
the parameter of the termination device is adjusted during boot up of the computer system or power on of the computer system; and
the termination device is configured to be disabled during a period that at least partially overlaps with training an integrated circuit (IC) device or a boot stage of the computer system.

9. A method comprises:
outputting, via control circuitry of a termination device, a first signal to a communication bus of a computer system, wherein the control circuitry is configured to be connected to the communication bus of the computer system;
adjusting, via the control circuitry, a parameter of the termination device based on a data signal associated with the first signal; and
outputting, via the control circuitry, a second signal to the communication bus based on the adjusted parameter.

10. The method of claim 9, wherein the data signal is output from a processing device to an integrated circuit (IC) device along the communication bus, and the data signal is sampled by the IC device, and wherein adjusting the parameter of the termination device is based on the sampled data signal.

11. The method of claim 9, wherein the first signal is a first voltage signal, and the second signal is a second voltage signal, wherein a voltage value of the first voltage signal differs from a voltage value of the second voltage signal.

12. The method of claim 11, wherein adjusting the parameter of the termination device comprises adjusting a tunable output voltage of the termination device.

13. The method of claim 11, wherein a signal integrity of the data signal is determined, and wherein adjusting the parameter of the termination device is based on the signal integrity of the data signal.

14. The method of claim 13, wherein determining the signal integrity for the data signal comprises determining a size of an eye opening of an eye diagram associated with the data signal.

15. The method of claim 9, wherein adjusting the parameter of the termination device comprises adjusting a resistance of one or more resistors of the termination device.

16. The method of claim 9, further comprising at least one of:
adjusting the parameter of during boot up of the computer system or power on of the computer system; and
disabling the termination device during a period that at least partially overlaps with training an integrated circuit (IC) device or a boot stage of a computer system.

17. A computer system comprising:
a processing device configured to output data signals;
an integrated circuit (IC) device connected to the processing device via a communication bus and configured to receive and sample the data signals; and
a termination device connected to the processing device via the communication bus, wherein a parameter of the termination device is adjustable based on the sampled data signals.

18. The computer system of claim 17, wherein the parameter of the termination device is adjusted to tune the termination device based on the sampled data signals during a boot process of the computer system.

19. The computer system of claim 17, wherein the termination device is configured to adjust the parameter of the termination device by adjusting a voltage of a voltage signal output by the termination device onto the communication bus based on the sampled data signals.

20. The computer system of claim 17, wherein the processing device is configured to output control signals to the termination device, and wherein the termination device is configured to receive the control signals and output voltage signals having different voltage values based on the control signals, and wherein the IC device is configured to generate samples for each of the voltage signals to sample the data signals, and determine a signal integrity for each voltage signal based on respective samples.
